(19) United States
(12) Patent Application Publication
(10) Pub. No.: US 2014/0328505 A1
(43) Pub. Date: Nov. 6, 2014

(54) SOUND FIELD ADAPTATION BASED UPON USER TRACKING

(71) Applicant: MICROSOFT CORPORATION, Redmond, WA (US)

(72) Inventors: Chad Robert Heinemann, Lynnwood, WA (US); Andrew William Lovitt, Redmond, WA (US)

(73) Assignee: Microsoft Corporation, Redmond, WA (US)

(21) Appl. No.: 13/875,924

(22) Filed: May 2, 2013

(51) Int. Cl. H04S 7/00

(52) U.S. Cl. CPC H04S 7/303
USPC 381/303

(57) ABSTRACT

Embodiments are disclosed that relate to adapting sound fields in an environment. For example, one disclosed embodiment includes receiving information regarding a user in the environment, and outputting one or more audio signals to one or more speakers based on the information. The method further includes detecting a change in the information that indicates a change in the position of one or more of the user and an object related to the user in the environment, and modifying the one or more audio signals output to the one or more speakers based on the change in the information.

### BACKGROUND

Audio systems may produce audio signals for output to speakers in a room or other environment. Various settings related to the audio signals may be adjusted based on a speaker setup in the environment. For example, audio signals provided to a surround sound speaker system may be calibrated to provide an audio “sweet spot” within the space. Likewise, users may consume audio via headphones in some listening environments. In such environments, a head-related transfer function (HRTF) may be utilized to reproduce a surround sound experience via the headphone speakers.

### SUMMARY

Embodiments for adapting sound fields in an environment are disclosed. For example, one disclosed embodiment provides a method including receiving information regarding a user in the environment, and outputting one or more audio signals to one or more speakers based on the information. The method further comprises detecting a change in the information that indicates a change in the position of one or more of the user and an object related to the user in the environment, and modifying the one or more audio signals output to the one or more speakers based on the change in the information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of an example use environment for an audio output system according to an embodiment of the present disclosure.

FIGS. 2A-7 show example sound adaptation scenarios in accordance with the present disclosure.

FIG. 8 shows an embodiment of a method for adapting sound fields in an environment.

FIG. 9 schematically shows an embodiment of a computing system.

### DETAILED DESCRIPTION

Audio systems may provide audio signals for output to one or more speakers, wherein the audio signals may be adapted to specific speaker configurations. For example, audio content may be adapted to common output configurations and formats, such as 7.1, 9.1, and 5.1 surround sound formats, as well as two-speaker stereo (2.0) format.

An audio receiver and renderer may operate to produce a selected representation of audio content given a speaker set-up in a user's listening environment. As such, some audio output systems may calibrate audio output to speakers based on a local environment in order to provide one or more audio “sweet spots” within the environment. Here, the term “sweet spot” refers to a focal point in a speaker system where a user is capable of hearing an audio mix as it was intended to be heard by the mixer.

However, such audio output calibration and/or manipulation techniques provide a constant sound experience to users in an environment, as the location of a “sweet spot” is static. Thus, if a user moves away from a speaker “sweet spot” in a room, a quality of the audio output perceived by the user may be reduced relative to the quality at the sweet spot. Further, such calibration and/or manipulation techniques may be acoustically based and therefore susceptible to room noise during calibration. Additionally, in the case of headphones, the audio mix provided to the user via the headphones may remain unchanged as the user changes orientation and location in an environment.

Thus, natural user interface (NUI) tracking-based feedback may be used to track positions of one or more users in an environment, and sound signals provided to speakers may be varied based upon the position of the user(s) in the environment. User tracking may be performed via any suitable sensors, including but not limited to one or more depth cameras or other image-based depth sensing systems, two-dimensional cameras, directional microphone arrays, other acoustic depth sensing systems that allow position determination (e.g. sonar systems and/or systems based upon reverberation times), and/or other sensors capable of providing positional information.

A natural user interface system may be able to determine such positional information as a location of a user in an environment, an orientation of the user in the environment, a head position of the user, gestural and postural information, and gaze direction and gaze focus location. Further, a natural user interface system may be able to determine and characterize various features of an environment, such as a size of the environment, a layout of the environment, geometry of the environment, objects in the environment, textures of surfaces in the environment, etc. Such information then may be used by a sound field adaptation system to dynamically adapt sound fields provided to users in an environment in order to provide an enhanced listening experience. A natural user interface system could also specifically determine obstructions in a sound field so that the sound field presented to users in the environment are adapted or modified to compensate for the identified obstructions. For example, if a person is standing in a path of the sound field for another user, the sound field presented to the user may be adapted so that it seems like the person is not there.

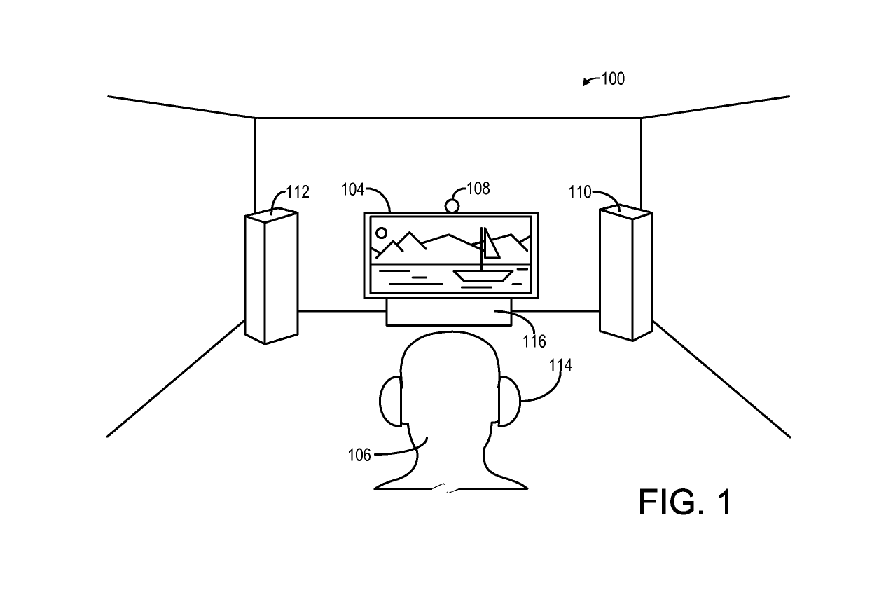

FIG. 1 shows a schematic depiction of an example use environment 100 for an audio output system, wherein environment 100 takes the form of a room. It should be understood that environment 100 is presented for the purpose of example, and that a use environment may take any other suitable form. By way of example, environment 100 includes an audio output system 116, a display device 104, and speakers 112 and 110. Audio output system 116 and display device 104 may be included in a television, a gaming system, a stereo system, and/or other suitable computing system. It should be understood that although FIG. 1 shows a display device 104, in some examples, environment 100 may not include any display device. Further, it should be understood that although FIG. 1 shows a single display device 104, in other examples, environment 100 may include a plurality of display devices positioned at different locations in the environment or a plurality of devices may be included in a single device, e.g., a television with a game console in it.

The audio output system 116 is configured to output audio signals to speakers 112 and 110. It should be understood that, though FIG. 1 shows only two speakers in environment 100, any suitable number of speakers may be included in environment 100. For example, speakers 112 and 110 may be included in a surround sound speaker system which includes a plurality of speakers positioned at different locations in environment 100. Audio content output by audio output system 116 may be adapted to a particular speaker arrangement in environment 100, e.g., 7.1, 9.1, 5.1, or 2.0 audio output formats.

FIG. 1 shows a user 106 positioned at a central location in environment 100 and viewing content presented on display device 104. As user 106 is positioned at a center location between speakers 112 and 110, rendering of audio content output by audio output system 116 may be optimized for listening at this center location, or “sweet spot.” Further, in some examples, one or more users in environment 100 may be wearing headphones 114 that receive output from audio output system 116.

Environment 100 also includes a sensor system 108 configured to track one or more users in environment 100. Sensor system 108 may provide data suitable for tracking positions of users in environment 100 Sensor system 108 may include any suitable sensing devices, including but not limited to one or more of a depth camera, an IR image sensor, a visible light (e.g. RGB) image sensor, an acoustic sensor such as a directional microphone array, a sonar system, and/or other acoustical methods (e.g. based on reverberation times).

Based on data received from sensor system 108, positional information of user 106 may be determined and tracked in real-time. Examples of positional information of a user which may be tracked include location of a user or a portion of a user, e.g., a user's head, orientation of a user or a portion of a user, e.g., a user's head, posture of a user or a portion of a user, e.g., a user's head or a body posture of the user, and user gestures. Further, sensor system 108 may be used to parameterize various features of environment 100 including a size of the environment, a layout of the environment, geometry of the environment, objects in the environment and their relative position to user 106, textures of surfaces in the environment, etc.

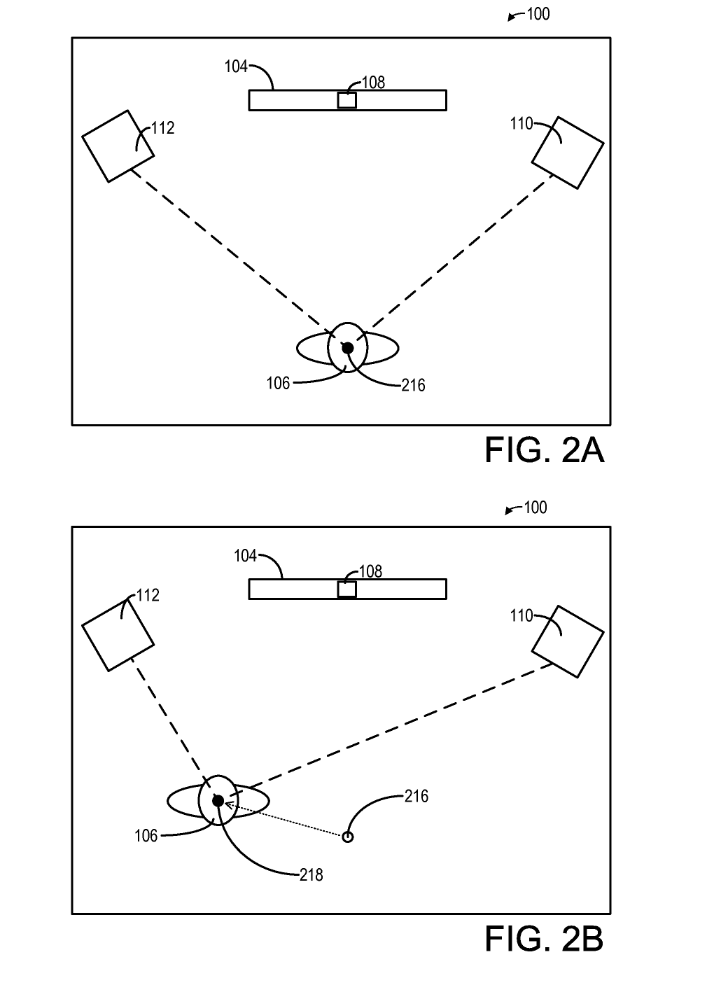

Real-time position and orientation information of users in environment 100 captured from a user tracking system via sensor system 108 may be used to adapt sounds presented to users in the environment. For example, FIG. 2A shows user 106 at a first position in environment 100 and FIG. 2B shows user 106 at a second, different position in environment 100. In the examples shown in FIGS. 2A and 2B, user 106 is listening to sounds emitted from speakers 112 and 110 in environment 100. For example, audio associated with content presented on display device 104 may be output to speakers 112 and 110.

When user 106 is at the first position in environment 100 shown in FIG. 2A, a user tracking system may determine the location of user 106, e.g., via sensor system 108, and audio signals sent to the speakers may be modified accordingly. For example, based on this first position of user 106 in environment 100, the audio output to speakers 112 and 110 may be adjusted to position an acoustic “sweet spot” at a location 216 corresponding to the first position of user 106 in environment 100. More specifically, audio signals output to a first audio channel for speaker 112 and a second audio channel for speaker 110 may be selected based on the position of user 106 in environment 100.

In FIG. 2B, user 106 has moved toward the left side of environment 100 to a second position. The user tracking system determines this new location of user 106, and updates the “sweet spot” to a new location 218 by adjusting the audio signals provided to speakers 112 and 110. The audio signals may be adjusted in any suitable manner. The audio signals may be digital or analog and may comprise any mathematical combination of components. For example, the “sweet spot” may be relocated by adjusting per-channel audio delays and/or gain.

Further, assuming that a small amount of buffering occurs for all channels inside an audio renderer, e.g., an amount based upon a maximum amount of adjustment the system can make, in some embodiments, the data buffer for each speaker channel may be dynamically resized depending on the speaker and user locations in order to preserve intended speaker time of arrivals. This delay may be calculated, for example, using the head location of user 106 in 3-dimensional space, the approximate speaker locations, the user location, and the speed of sound. Furthermore, a final modification for each channel can be made in order to counteract the sound power loss (or gain) compared to expected power at the center location. Also, filtering gain and/or time of arrival adjustments over time may be performed to reduce signal changes, for example, for a more pleasant user experience or due to hardware limitations of the system.

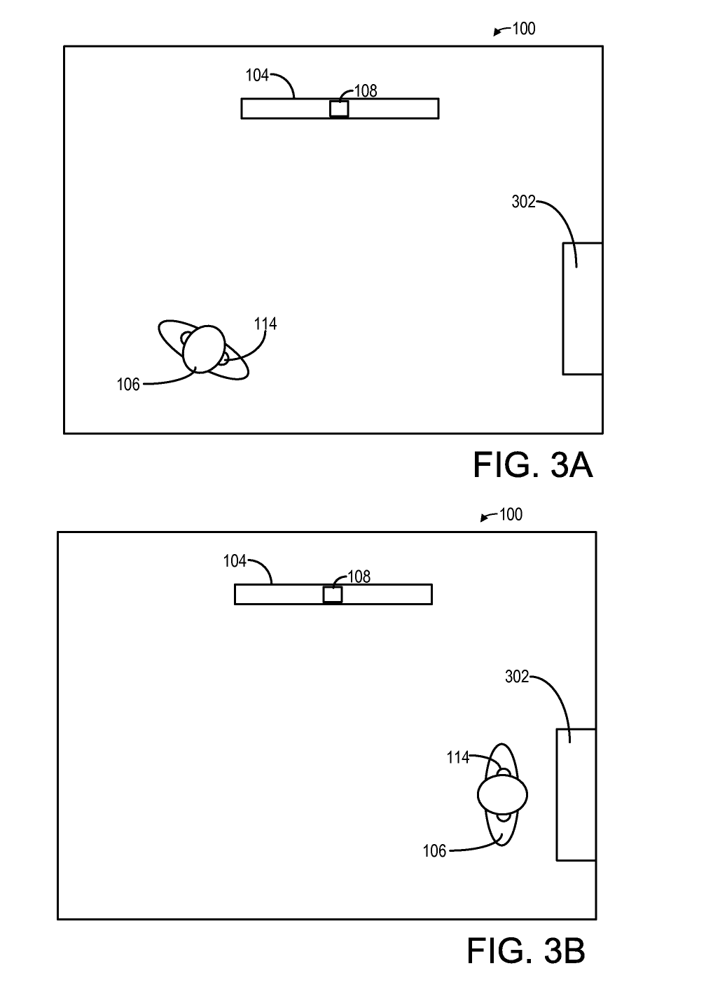

FIGS. 3A and 3B show an example scenario illustrating an adapting of sound fields presented to user 106 based on an orientation of user 106 in the environment. FIG. 3A shows user 106 at a first position with a first orientation in environment 100, and FIG. 3B shows user 106 at a second, different position with a second, different orientation in environment 100. In the examples shown in FIGS. 3A and 3B, user 106 is listening to sounds associated with content presented on display device 104 via headphones 114.

FIG. 3A shows user 106 in a first position and orientation looking towards display device 104. When user 106 is at the first position and orientation in environment 100 shown in FIG. 3A, a user tracking system may determine the orientation of user 106 relative to various objects in environment 100, e.g., relative to display device 104 and relative to a bookcase 302, and audio signals sent to the headphones may be modified accordingly. For example, based on this first orientation of user 106 in environment 100, the audio output to speakers in headphones 114 may be adjusted so that left and right speakers in the headphones have stereo output consistent with the location of the user relative to display device 104. As a more specific example, user 106 may be watching a movie displayed on display device 104, and left and right volume levels of audio output to headphones 114 may be substantially similar for the user based upon the orientation.

Next regarding FIG. 3B, user 106 has changed orientation to face bookcase 302. The user tracking system may determine this new orientation of user 106, and audio output to headphones 114 may be modified accordingly. For example, since the user's head is oriented toward bookcase 302, which may indicate the user 106 has shifted attention from display device 104 to the bookcase 302 to look at books, the audio output to the left and right channels of headphones 114 may be modified to de-emphasize the sounds associated with the content presented on display device 104. Further, an HRTF may be applied to the audio signals sent to headphones 114 in order to position the sounds associated with the display device content at a location behind and to the left of user 106. As another example, as user 106 is facing away from display device 104, the volume of audio associated with content presented on the display device may be reduced or muted. As used herein, the term “HRTF” may include any suitable audio path transfer function applied to audio signals based on user position. As one non-limiting example, HRTF's may be used to determine what a user's left and right ear receive in the direct paths from some sound source at some position from the user's head. As another non-limiting example, an environment of the user, e.g., a room (real or virtual) within which the user is positioned, may be modeled and echo paths based on objects in the environment may be added to the sound sources.

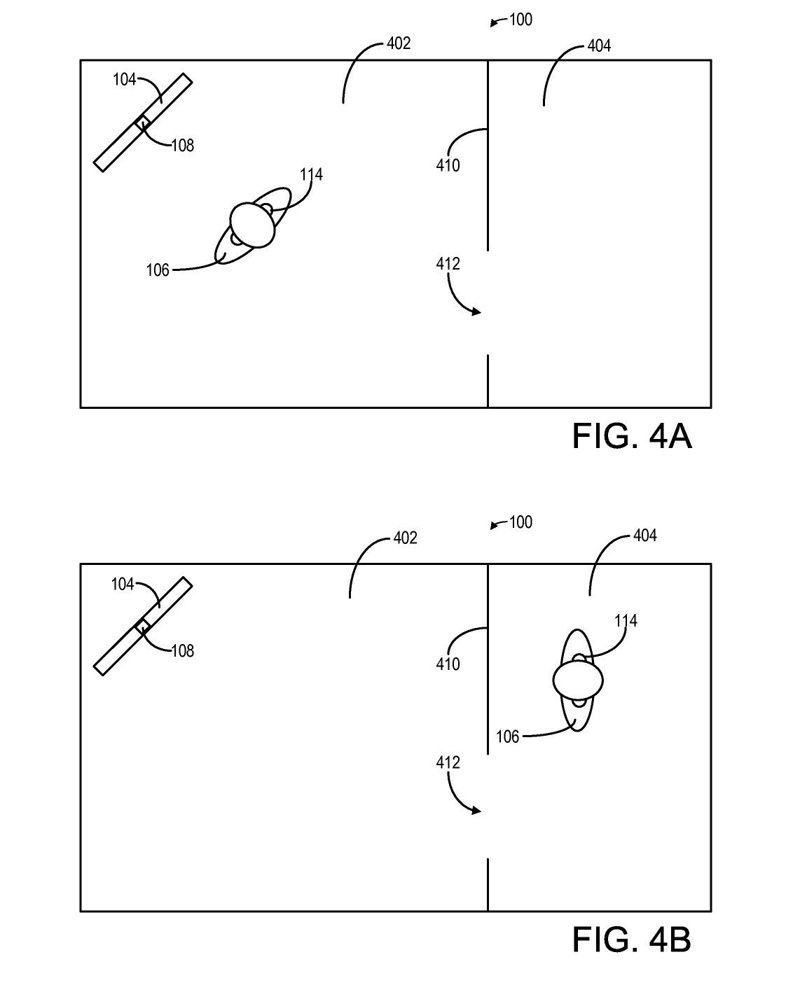

FIGS. 4A and 4B show an example scenario illustrating an adapting of sound fields presented to user 106 in an environment 100 including a first room 402 and a second room 404. In FIGS. 4A and 4B, first room 402 includes a display device 104 and second room 404 does not have a display device. Second room 404 is separated from first room 402 by a wall 410 including a doorway 412.

FIG. 4A shows user 106 positioned within first room 402 facing display device 104. Display device 104 may be an output for a gaming system, and user 106 may be interacting with the gaming system and listening to audio output associated with a displayed game via headphones 114. A user tracking system may determine the position and orientation of user 106 in room 402, and audio output may be provided to the user via headphones 114 based on the position and orientation of the user in room 402.

In FIG. 4B, user 106 has moved into second room 404 via doorway 412, and thus is separated from display device 104 by wall 410. The user tracking system may determine that the user 106 has left the room containing display device 104, and may modify output to headphones 114 accordingly. For example, audio output associated with the content provided on display device 104 may be muted or reduced in response to user 106 leaving room 402 and going into the second room 404.

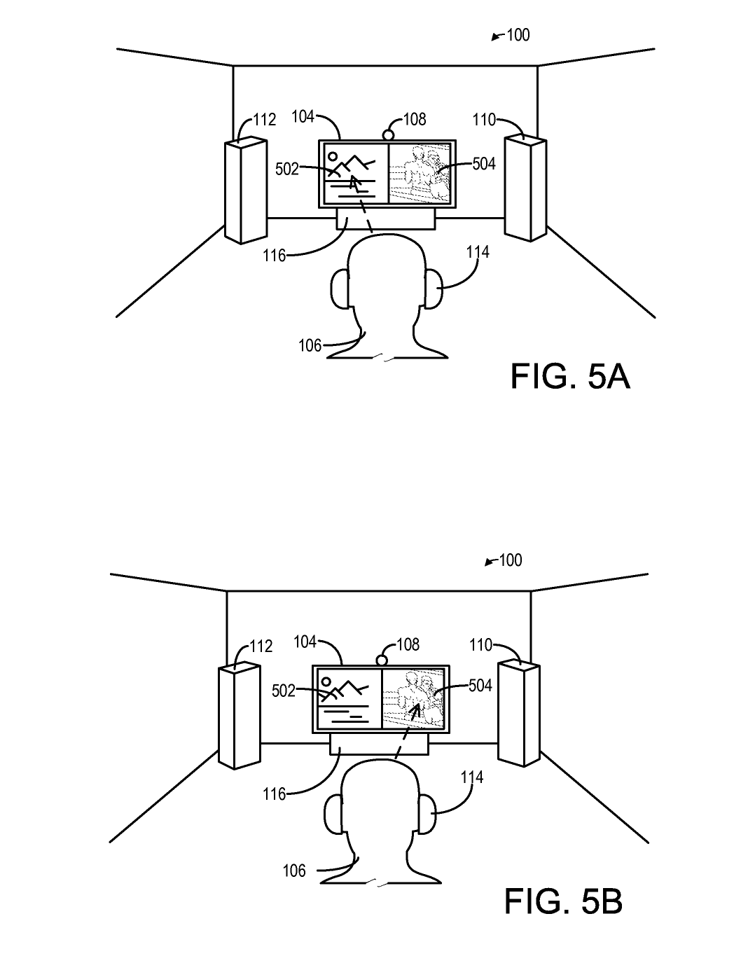

FIGS. 5A and 5B show an example of an adapting sound fields presented to user 106 in an environment 100 including a display device with a split screen display. A first screen 502 is displayed on a left region of display device 104 and a second screen 504 is displayed on a right side of display device 104. Display device 104 is depicted as a television displaying a nature program on first screen 502 and a boxing match on second screen 504. The audio output system 116 may send audio signals associated with content presented on display device to speakers, e.g. speaker 112 and speaker 110, and/or to headphones 114 worn by user 106.

In FIG. 5A, user 106 is gazing or focusing on first screen 502. The user tracking system may determine a location or direction of the user's gaze or focus, e.g., based on a head orientation of the user, a body posture of the user, eye-tracking data, or any other suitable data obtained via sensor system 108. In response to determining that user 106 is focusing on first screen 502, audio signals sent to the speakers and/or headphones 114 may be modified based on the user's gaze or focus. For example, since the user 106 is focusing on first screen 502, audio associated with the first screen 502 (e.g. sounds associated with the nature program) may be output to the speakers and/or headphones. Further, audio associated with the second screen 504 may not be output to the speakers or headphones.

In FIG. 5B, user 106 has changed focus from the first screen 502 to the second screen 504. The user tracking system may detect this change in user focus, e.g., based on sensor system 108, to determine the new location or direction of the user's gaze. In response to determining that user 106 is focusing on second screen 504, audio signals sent to the speakers and/or headphones 114 may be modified based on this change in user focus. For example, since the user 106 is now focusing on second screen 504, audio associated with the second screen 504 (e.g. the boxing match) may be output to the speakers and/or headphones. Further, audio associated with the first screen 502 may be muted since the user is no longer focusing on the first screen 502 in FIG. 5B.

Though FIGS. 5A and 5B show a single display device including multiple different screens, in some examples, environment 100 may include a plurality of different display devices each displaying different content. As such, the audio content provided to the user via the speakers and/or headphones may depend on which particular display device the user is focused on as described above in the context of split screens. Further, in some embodiments, different sounds within an audio mix may be emphasized depending upon a location at which a user is gazing on a single display showing a single screen of content to highlight sounds associated with the object displayed at that location on the screen. For example, if a user is watching concert footage, a volume of drums in the mix may be increased if the user is gazing at a drummer displayed on the display.

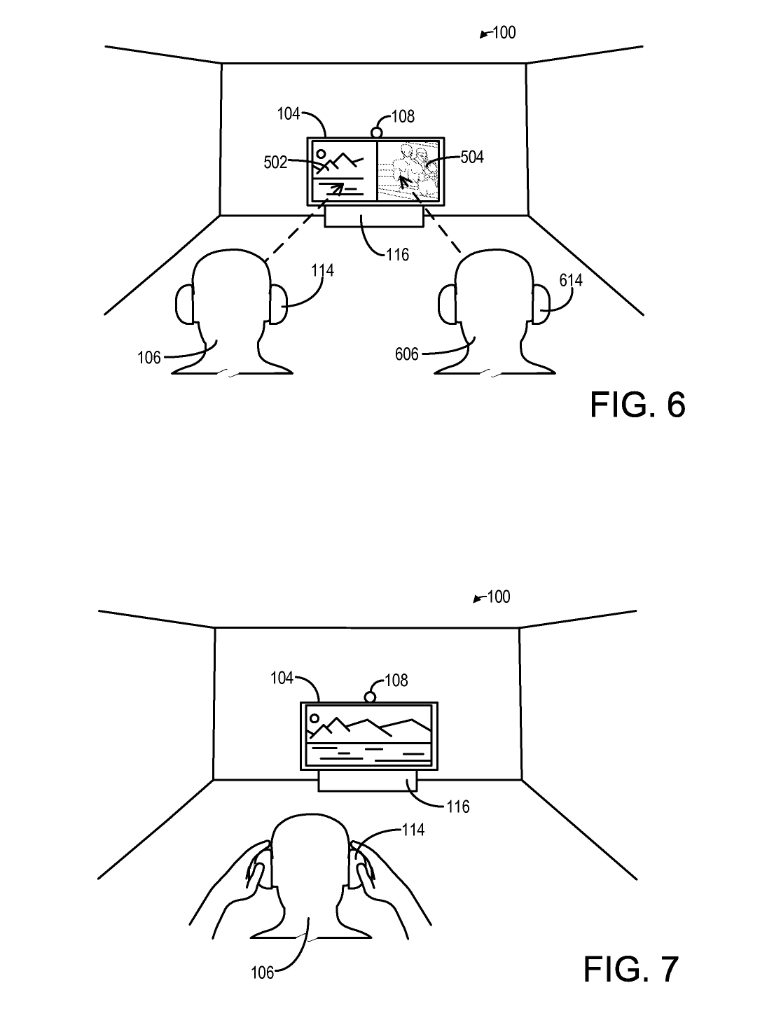

FIG. 6 shows an example scenario illustrating an adapting of sound fields presented to a first user 106 and a second user 606 in an environment 100 including a display device 104 in a split screen display mode. As described above with regard to FIGS. 5A and 5B, a first screen 502 is displayed on a left region of display device 104 and a second screen 504 is displayed on a right side of display device 104.

In FIG. 6, first user 106 is focusing on first screen 502, which is displaying the nature program, and second user 606 is focusing on second screen 504, which is displaying the boxing match. The user tracking system determines the location and focus direction, e.g., via sensor system 108, of the first user 106 and second user 606 and modifies the audio output to headphones 114 and 614 accordingly. For example, since first user 106 is positioned near and focusing on first screen 502, audio associated with the content displayed on first screen 502 is output to headphones 114 worn by user 106 whereas audio output associated with content on second screen 504 is not output to headphones 114. Likewise, since second user 606 is positioned near and focusing on second screen 504, audio associated with the content displayed on second screen 504 is output to headphones 614 worn by user 606 whereas audio output associated with content on first screen 502 is not output to headphones 614. Further, it will be understood that any sound field, whether provided by headphone speakers or non-headphone speakers, may be created and adapted for each user as described herein.

FIG. 7 shows an example scenario illustrating adapting sound fields presented to user 106 based on gestures of the user. In FIG. 7, a user is watching content on a display device 104, e.g., a television, and is listening to sounds associated with the content via headphones 114. The user tracking system may determine gesture or posture information of user 106, e.g., via sensor system 108, and modify sounds output to the headphones accordingly. For example, FIG. 7 shows user 106 performing a gesture where the user's hands are covering the user's ears. In response to detection of this gesture by the user tracking system, audio output to headphones 114 may be at least partially muted to simulate an audio effect of user 106 covering their ears to block out sound.

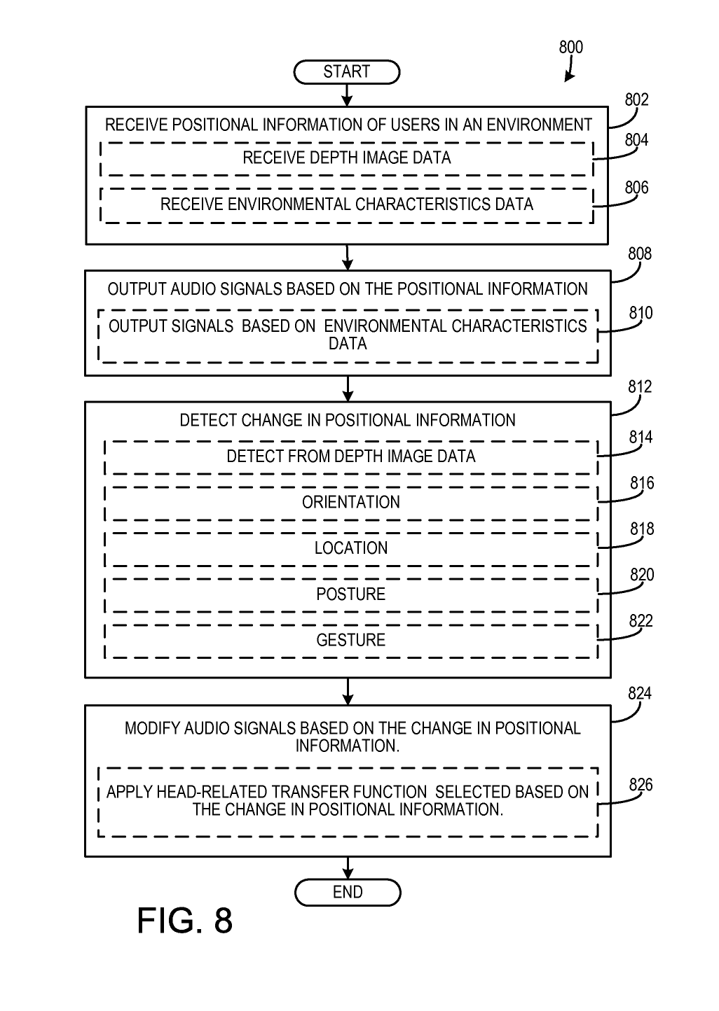

FIG. 8 shows a flow diagram depicting an example embodiment of a method 800 for adapting sound fields in an environment based on real-time positional information of users in the environment. For example, a user tracking interface with one or more sensors may be used to continuously track user location, orientation, posture, gesture, etc. as the user changes position within the environment. In some examples, this user positional information may be fed into an audio renderer in order to adjust a sound field presented to the user. In another example embodiment, audio signals may be received from an audio renderer and then modified based on user positional information.

At 802, method 800 includes receiving positional information of users in an environment. For example, at 804, method 800 may include receiving depth image data capturing of one or more users in the environment, and/or other suitable sensor data, and determining the positional information from the sensor data. The positional information may indicate one or more of a location, an orientation, a gesture, a posture, and a gaze direction or location of focus of one or more users in the environment. As a more specific non-limiting example, a depth camera may be used to determine a user's head position and orientation in 3-space, in order to approximate the positions of a user's ears.

Further, as indicated at 806, in some embodiments method 800 may include receiving environmental characteristics data. For example, depth images from a depth camera may be used to determine and parameterize various features or characteristics of an environment. Example characteristics of an environment which may be determined include, but are not limited to, size, geometry, layout, surface location, and surface texture.

At 808, method 800 includes outputting audio signals determined based on the positional information. For example, one or more audio signals may be output to one or more speakers based on the positional information of the users in the environment determined from the user tracking system. For example, the one or more speakers may be included in a surround sound speaker system and/or may include headphones worn by one or more users in the environment. As remarked above, in some examples, positional information may be provided to an audio renderer and audio signals may be modified based on the positional information at the audio renderer. However, in alternative embodiments, the audio signals may be received from an audio renderer and then modified based on user positional information.

The sound signals may be determined in any suitable manner. For example, in some embodiments, a first HRTF may be applied to audio signals based upon the first positional information of the user. The first HRTF may be determined, for example, by locating the HRTF in a look-up table of HRTFs based upon the positional information, as described in more detail below. In other embodiments, a user location, orientation, posture, or other positional information may be utilized to determine a gain, delay, and/or other signal processing to apply to one or more audio signals.

Further, in another example scenario, a user focus on an identified object may be determined, and one or more audio signals of a plurality of audio signals may be modified in a first manner to emphasize sounds associated with the identified object in an audio mix. Sounds associated with the identified object in an audio mix may include specific sounds in the audio mix and may be subcomponents of the audio mix, e.g., individual audio tracks, features exposed by audio signal processing, etc. As a more specific example, the identified object may be displayed on a display device in the environment, and sounds associated with the identified object may be output to headphones worn by a user focusing on the object.

Continuing with FIG. 8, in some embodiments method 800 may include, at 810, outputting audio signals to speakers based on environmental characteristics data. For example, signal processing may be utilized to determine location and delay information of the user's media sources in a particular environment, and audio output adjusted accordingly. As a more specific example, the audio signals may be processed with an amount of reverberation based on a size of the room.

At 812, method 800 includes detecting a change in positional information. For example, the user tracking system may be used to detect a change in the positional information that indicates a change in the position of one or more users in the environment. The change in positional information may be detected in any suitable manner. For example, as indicated at 814, method 800 may include receiving depth image data and detecting a change in positional information from the depth image data. It will be understood that any other suitable sensor data besides or in addition to depth image data also may be utilized.

The change in positional information may comprise any suitable type of change. For example, the change may correspond to a change in user orientation 816, location 818, posture 820, gesture 822, gaze direction or location of gaze focus, etc. Further, the positional information may comprise information regarding the position of two or more users in the environment. In this example, audio output to speakers associated with the different users may be adjusted based on each user's updated positional information.

At 824, method 800 includes modifying audio signals output to one or more of a plurality of speakers based on the change in positional information. As mentioned above, the audio signals may be modified in any suitable manner. For example, a user location, orientation, posture, or other positional information may be utilized to determine a gain, delay, and/or other signal processing to apply to one or more audio signals.

Also, an HRTF for the changed position may be obtained (e.g. via a look up table or other suitable manner), and the HRTF may be applied to the audio signals, as indicated at 826. As a more specific example, when headphones are used, some type of HRTF down mix is often applied to convert a speaker mix with many channels down to stereo. As such, a head-related transfer function database, look-up table, or other data store comprising head-related transfer functions for planar or spherical usage may be used to modify audio output to headphones. In a planar usage, several head-related transfer functions might be available at different points on a circle, where the circle boundary represents sound source locations and the circle center represents the user position. Spherical usage functions similarly with extrapolation to a sphere. In either case, head-related transfer function “points” represent valid transform locations, or filters, from a particular location on the boundary to the user location, one for each ear. For example, a technique for creating a stereo down mix from a 5.1 mix would run a single set of left and right filters, one for each source channel, over the source content. Such processing would produce a 3D audio effect. Head-orientation tracked by the user tracking system may be used to edit these head-related transfer functions in real-time. For example, given actual user head direction and orientation at any time, and given a head-related transfer function database as detailed above, the audio renderer can interpolate between head-related transfer function filters in order to maintain the sound field in a determined location, regardless of user head movement. Such processing may add an increased level of realism to the audio output to the headphones as the user changes orientation in the environment, since the sound field is constantly adapted to the user's orientation.

Further, in some examples, audio signals output to a plurality of speakers may be modified based on positional information of a user relative to one or more objects in the environment, such as an identity of an object at a location at which the user is determined to have focus. As a more specific example, one or more audio signals of a plurality of audio signals may be modified in a first manner to emphasize sounds associated with a first object in an audio mix when a user focuses on the first object, and one or more audio signals of a plurality of audio signals may be modified in a second manner to emphasize sounds associated with a second object in an audio mix when a user focuses on the second object.

Audio output also may be modified differently for different users in the environment depending on positional information of each user. For example, positional information regarding the position of two or more users in the environment may be determined by the user tracking system, and a change in positional information that indicates a change in position of a first user may be detected so that one or more audio signals output to one or more speakers associated with the first user may be modified. Further, a change in positional information that indicates a change in position of a second user may be detected, and one or more audio signals output to one or more speakers associated with the second user may be modified.

In this way, user tracking-based data may be used to adapt audio output to provide a more optimal experience for users with different locations, orientations, gestures, and postures. Further, room geometry can be parameterized and used to enhance the experience for a given environment leading to a more optimal listening experience across the listening environment.

In some embodiments, the methods and processes described above may be tied to a computing system of one or more computing devices. In particular, such methods and processes may be implemented as a computer-application program or service, an application-programming interface (API), a library, and/or other computer-program product.

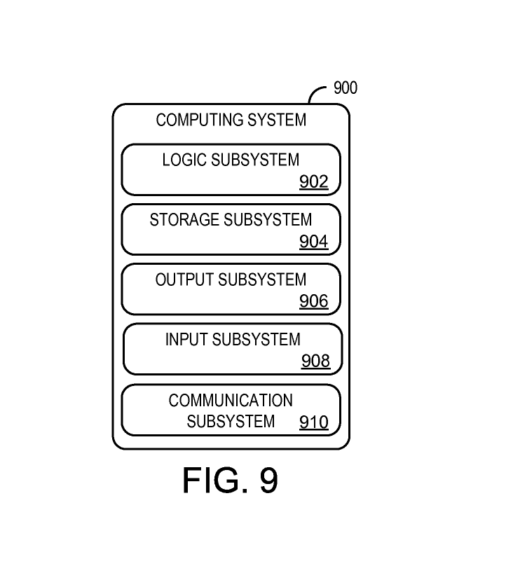

FIG. 9 schematically shows a non-limiting embodiment of a computing system 900 that can enact one or more of the methods and processes described above. Display device 104 may be one non-limiting example of computing system 900. As another example, audio output system 116 may be another non-limiting example of computing system 900. Computing system 900 is shown in simplified form. It will be understood that virtually any computer architecture may be used without departing from the scope of this disclosure. In different embodiments, computing system 900 may take the form of a display device, wearable computing device, mainframe computer, server computer, desktop computer, laptop computer, tablet computer, home-entertainment computer, network computing device, gaming device, mobile computing device, mobile communication device (e.g., smart phone), etc.

Computing system 900 includes a logic subsystem 902 and a storage subsystem 904. Computing system 900 may optionally include an output subsystem 906, input subsystem 908, communication subsystem 910, and/or other components not shown in FIG. 9.

Logic subsystem 902 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

Storage subsystem 904 includes one or more physical devices configured to hold data and/or instructions executable by the logic subsystem to implement the methods and processes described herein. When such methods and processes are implemented, the state of storage subsystem 904 may be transformed—e.g., to hold different data.

Storage subsystem 904 may include removable media and/or built-in devices. Storage subsystem 904 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage subsystem 904 may include volatile, nonvolatile, dynamic, static, read/write, read-only, random-access, sequential-access, location-addressable, file-addressable, and/or content-addressable devices.

It will be appreciated that storage subsystem 904 includes one or more physical devices and excludes propagating signals per se. However, in some embodiments, aspects of the instructions described herein may be propagated by a pure signal (e.g., an electromagnetic signal, an optical signal, etc.) via a communications medium, as opposed to being stored on a storage device. Furthermore, data and/or other forms of information pertaining to the present disclosure may be propagated by a pure signal.

In some embodiments, aspects of logic subsystem 902 and of storage subsystem 904 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

When included, output subsystem 906 may be used to present a visual representation of data held by storage subsystem 904. This visual representation may take the form of a graphical user interface (GUI). As the herein described methods and processes change the data held by the storage subsystem, and thus transform the state of the storage subsystem, the state of output subsystem 906 may likewise be transformed to visually represent changes in the underlying data. Output subsystem 906 may include one or more display devices utilizing virtually any type of technology. Such display devices may be combined with logic subsystem 902 and/or storage subsystem 904 in a shared enclosure, or such display devices may be peripheral display devices.

As another example, when included, output subsystem may be used to present audio representations of data held by storage subsystem 904. These audio representations may take the form of one or more audio signals output to one or more speakers. As the herein described methods and processes change the data held by the storage subsystem, and thus transform the state of the storage subsystem, the state of output subsystem 906 may likewise be transformed represent changes in the underlying data via audio signals. Output subsystem 906 may include one or more audio rendering devices utilizing virtually any type of technology. Such audio devices may be combined with logic subsystem 902 and/or storage subsystem 904 in a shared enclosure, or such audio devices may be peripheral audio devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. On a computing device, a method for adapting sound fields in an environment, the method comprising:
receiving information regarding a position of one or more of a user and an object related to the user in the environment;
outputting one or more audio signals to one or more speakers based on the information;
detecting a change in the information that indicates a change in the position of the user in the environment; and
modifying the one or more audio signals output to the one or more speakers based on the change in the information.

2. The method of claim 1, wherein the information indicates one or more of a location, an orientation, a posture, and a portion of the one or more of the user and the object in the environment.

3. The method of claim 1, further comprising receiving environmental characteristics data, and modifying the one or more audio signals output to the one or more speakers based on the environmental characteristics data.

4. The method of claim 1, further comprising modifying the one or more audio signals output to the plurality of speakers based on information of the user relative to one or more objects in the environment.

5. The method of claim 1, further comprising modifying the one or more audio signals output to the one or more speakers based on an identity of an object at a location at which the user is determined to have focus.

6. The method of claim 1, wherein modifying the one or more audio signals output to the one or more speakers comprises applying a head-related transfer function selected based on the change in the information.

7. The method of claim 6, wherein the head-related transfer function is selected from a look-up table based upon the information.

8. The method of claim 1, wherein the information regards the position of two or more users in the environment, and wherein the method further comprises:
detecting in a change in information that indicates a change in position of a first user and modifying one or more audio signals output to one or more speakers associated with the first user; and
detecting in a change in information that indicates a change in position of a second user and modifying one or more audio signals output to one or more speakers associated with the second user.

9. The method of claim 1, wherein the one or more audio signals are received from an audio renderer.

10. The method of claim 1, wherein the information of the user in the environment is at least partially determined from data received from a depth sensing system.

11. On a computing device, a method for adapting sound fields in an environment, the method comprising:
receiving depth information of the environment;
determining from the depth information first positional information regarding a position of a user in the environment;
applying a first head-related transfer function to audio signals based upon the first positional information;
determining from depth information second positional information;
determining from the second positional information that the user has changed position; and
applying a second head related transfer function to audio signals based upon the second positional information.

12. The method of claim 11, wherein the first and second positional information regarding the position of the user in the environment indicates one or more of a location, an orientation, and a posture of the user in the environment.

13. The method of claim 11, further comprising retrieving the first head related transfer function and the second head related transfer function from a look-up table.

14. The method of claim 11, further comprising modifying the audio signals based on positional information regarding a position of the user relative to one or more objects in the environment.

15. The method of claim 11, further comprising modifying the audio signals based on an identity of an object at a location at which the user is determined to have focus.

16. The method of claim 11, wherein the depth information comprises depth images received from a depth camera.

17. A computing device, comprising:
a logic subsystem; and
a storage subsystem comprising instructions stored thereon that are executable by the logic subsystem to:
receive depth images from a depth camera;
from the depth images, locate one or more users in the environment;
determine a user focus on a first object in the environment from the depth information;
modify one or more audio signals of a plurality of audio signals in a first manner to emphasize sounds associated with the first object in an audio mix;
from the depth information, determine a user focus on a second object in the environment; and
modify one or more audio signals of the plurality of audio signals in a second manner to emphasize sounds associated with the second object in the audio mix.

18. The device of claim 17, wherein the user focus on the first object is a first user focus and the user focus on the second object is a second user focus, and wherein the storage subsystem comprises instructions stored thereon are further executable by the logic subsystem to:
output the audio signals modified in the first manner to one or more speakers associated with the first user; and
output the audio signals modified in the second manner to one or more speakers associated with the second user.

19. The device of claim 17, wherein the user focus on the first object is a focus of a user at a first time and the user focus on the second object is a focus of the user at a second time, and
wherein the storage subsystem comprising instructions stored thereon are further executable by the logic subsystem to:
output the audio signals modified in the first manner to one or more speakers associated with the user at the first time; and
output the audio signals modified in the second manner to the one or more speakers associated with the user at the second time.

20. The device of claim 17, wherein the first and second objects are displayed on a display device in the environment.
